(19) United States
(12) Patent Application Publication
(10) Pub. No.: US 2026/0106916 A1
(43) Pub. Date: Apr. 16, 2026

(54) INTENT-BASED MANAGEMENT APPARATUS FOR SOFTWARE-DEFINED VEHICLES IN INTELLIGENT TRANSPORTATION SYSTEMS AND METHOD THEREOF

(71) Applicant: Research & Business Foundation Sungkyunkwan University, Suwon-si (KR)

(72) Inventors: Jaehoon JEONG, Busan (KR); Yiwen SHEN, Suwon-si (KR); Yoseop AHN, Suwon-si (KR); Mose GU, Suwon-si (KR)

(73) Assignee: Research & Business Foundation Sungkyunkwan University, Suwon-si (KR)

(21) Appl. No.: 19/247,836

(22) Filed: Jun. 24, 2025

(30) Foreign Application Priority Data
Jun. 24, 2024 (KR) 10-2024-0081595

(51) Int. Cl. H04L 67/50; H04L 41/0895; H04L 43/04

(52) U.S. Cl. CPC H04L 67/50; H04L 41/0895; H04L 43/04

(57) ABSTRACT

The present disclosure relates to a framework technology for managing and monitoring software-defined vehicles, wherein an intent-based management method for software-defined vehicles in a vehicular cloud registers service functions of software-defined vehicles, receives intent for the software-defined vehicles and converts the received intent into service policies corresponding to the intent, and delivers the service policies to the service functions of the software-defined vehicles connected via a network.

### CROSS-REFERENCE TO RELATED APPLICATION

This application claims the benefit under 35 USC § 119(a) of Korea Patent Application No. 10-2024-0081595 filed on Jun. 24, 2024, which are incorporated herein by reference for all purposes as if fully set forth herein.

### TECHNICAL FIELD

The present disclosure relates to a framework technology for managing and monitoring software-defined vehicles through a vehicular cloud and, more particularly, to an intent-based management apparatus and method for software-defined vehicles in an intelligent transportation system, and a recording medium recording the same.

### BACKGROUND ART

Over the past several decades, network management has dramatically evolved from manual configuration to advanced automatic management. This evolution has led to intent-based network (IBN) management and automation, which has been driven by several factors, including network complexity, scale, cost and efficiency, dynamic environments, service delivery, and security. The “intent” to manage a network refers to providing only what to achieve (i.e., declarative commands), rather than how to achieve the goal (i.e., imperative commands). This paradigm shift significantly alleviates the burden of network management due to increasingly complex networks. If a user (e.g., an administrator) is allowed to manage a network through their intent, the network is referred to as an intent-based network.

A system that manages an intent-based network is referred to as an Intent-Based System (IBS). The importance of intent-based systems has grown due to the complexity and scalability of modern networks. An intent-based system minimizes manual intervention, reduces costs, and enables rapid adaptation to dynamic changes, thereby enhancing efficiency. Intent-based network automation leverages advanced technologies such as artificial intelligence (AI), machine learning (ML), and software-defined networking (SDN) to automate network management. The intent-based network automation facilitates agile service delivery and provisioning and helps enforce security policies and compliance.

In addition to network management and automation, the automotive industry is witnessing a fundamental transformation, particularly with the emergence of Software-Defined Vehicles (SDVs). Alongside the rise of electric vehicles, SDVs—which implement various vehicle functions through software—have become new players on the path toward autonomous vehicles in smart road networks. Due to the massive number of vehicles produced by each vehicle manufacturer, the network and security for SDVs need to be remotely configured and monitored by the control center of each vehicle manufacturer. The in-vehicle network may be based on Gigabit Ethernet and consist of multiple subnets, including electronic control units (ECUs) and infotainment systems. However, direct configuration and monitoring of the network and security settings by an operator for the in-vehicle network incurs an issue of significant overhead. Therefore, a technical solution is required to address the issue above.

### PRIOR ART DOCUMENTS

### Non-Patent Documents

(Non-patent document 1) A. Clemm, L. Ciavaglia, L. Z. Granville, and J. Tantsura, “Intent-Based Networking-Concepts and Definitions,”RFC 9315, Oct. 2022.

(Non-patent document 2) A. Leivadeas and M. Falkner, “A Survey on Intent-Based Networking,” IEEE Communications Surveys & Tutorials, vol. 25, no. 1, pp. 625-655, 2023.

### SUMMARY OF INVENTION

### Technical Problem

The technical problem to be solved by the embodiments of the present disclosure is to address management difficulties related to functions implemented through software applied to a plurality of vehicles, as conventional vehicles evolve into electric vehicles and autonomous vehicles, to eliminate the substantial overhead that arises when an operator directly configures and monitors the network and security settings within a software-defined vehicle, and to prevent the increase of costs due to operating offline vehicle service centers.

### Technical Solution

To solve the technical problem above, a management apparatus for performing intent-based management for a software-defined vehicle (SDV) in a vehicular cloud according to one embodiment of the present disclosure comprises a cloud controller configured to receive intent for a software-defined vehicle, convert the intent into a corresponding service policy, and deliver the service policy to a service function of the software-defined vehicle connected through a network; and a cloud vendor's management system configured to provide images of virtualized service functions for vehicular cloud services and register the service functions and access information with the cloud controller.

In the intent-based management apparatus in a vehicular cloud according to one embodiment, the cloud controller may interpret the input intent and convert the input intent into a high-level service policy corresponding to the interpreted intent, select a service function suitable for a software-defined vehicle connected via a network through a controller-facing Interface and deliver the high-level service policy, thereby allowing the software-defined vehicle to convert the high-level service policy into a low-level service policy understood by the service function.

The intent-based management apparatus in a vehicular cloud according to one embodiment may further include a cloud analyzer that analyzes monitoring data related to service functions collected from a software-defined vehicle and provides policy reconfiguration or feedback to the cloud controller through an analytics Interface.

In the intent-based management apparatus in a vehicular cloud according to one embodiment, a cloud vendor's management system may transmit service function capability and access information for registration to the cloud controller via a registration interface or receive a service function (SF) query for searching for a requested service function, and exchange service function container images and service function characteristic information with a software-defined vehicle via a Vendor Management System-Facing Interface (VMS-Facing Interface).

To solve the technical problem above, a management apparatus for performing intent-based management for a software-defined vehicle (SDV) according to one embodiment of the present disclosure comprises a service function including at least one of network, security, and application service of the software-defined vehicle; a software-defined vehicle controller receiving a service policy generated in response to the intent for the software-defined vehicle from a vehicular cloud connected via a network and delivering the service policy to a service function supposed to perform the service policy; and a software-defined vehicle vendor's management system providing virtualized service function images for software-defined vehicle services and registering service functions and access information with the software-defined vehicle controller.

In the intent-based management apparatus for a software-defined vehicle according to one embodiment, the software-defined vehicle controller may receive, through a controller-facing interface, a high-level service policy generated in response to the intent for the software-defined vehicle from a vehicular cloud, convert the received high-level service policy into a low-level service policy understood by a service function, select a service function to perform the low-level service policy, and transmit the low-level service policy to the selected service function through an SF-facing interface.

The intent-based management apparatus for a software-defined vehicle according to one embodiment may further include a software-defined vehicle analyzer configured to analyze monitoring data collected from a service function through a monitoring interface to confirm the activity and performance of the service function, deliver policy reconfiguration or feedback information for resolving security and network issues to the software-defined vehicle controller through an analytics interface, and exchange at least one of security, network, or system-related analysis of the service functions with the vehicular cloud through an analyzer-facing interface.

To solve the technical problem above, an intent-based management method for a software-defined vehicle (SDV) in a vehicular cloud according to one embodiment of the present disclosure comprises registering a service function of the software-defined vehicle by a management apparatus, receiving intent for the software-defined vehicle and converting the received intent into a corresponding service policy by the management apparatus; and delivering the service policy to the service function of the software-defined vehicle connected through a network by the management apparatus.

In the intent-based management method in a vehicular cloud according to one embodiment of the present disclosure, the converting of the intent into the service policy may interpret the input intent and convert the input intent into a high-level service policy corresponding to the interpreted intent, and the delivering of the service policy may select a service function suitable for a software-defined vehicle connected through a network and deliver the high-level service policy, thereby allowing the software-defined vehicle to convert the high-level service policy into a low-level service policy understood by the service function.

To solve the technical problem above, an intent-based management method for a software-defined vehicle (SDV) according to one embodiment of the present disclosure comprises registering a service function including at least one of network, security, and application services of the software-defined vehicle by the management apparatus; receiving a service policy generated in response to the intent for the software-defined vehicle from a vehicular cloud connected through a network by the management apparatus; and delivering the received service policy to the service function supposed to perform the received service policy by the management apparatus.

In the intent-based management method for a software-defined vehicle according to one embodiment, the receiving of the service policy may receive a high-level service policy generated in response to the intent for the software-defined vehicle from the vehicular cloud, and the delivering of the service policy may convert the received high-level service policy into a low-level service policy understood by a service function, select a service function supposed to perform the low-level service policy, and deliver the low-level service policy.

The intent-based management method for a software-defined vehicle according to one embodiment may further include analyzing monitoring data collected from a service function and confirming the activity and performance of the service function; and delivering policy reconfiguration or feedback information for resolving security and network issues according to the analysis result.

Furthermore, in what follows, the present disclosure provides a computer-readable recording medium that records programs for executing the intent-based management methods in a computer.

### Effects Of The Invention

According to the embodiments of the present disclosure, by efficiently organizing virtualized network functions and applications together to enable agile reconfiguration of network resources and flexible updates of software-defined vehicle applications, it is possible to address management difficulties associated with functions implemented through software applied to a plurality of vehicles, reduce overhead caused by network and security configuration and monitoring within software-defined vehicles, and prevent the increase of costs due to operating offline vehicle service centers.

### BRIEF DESCRIPTION OF THE DRAWINGS

The accompanying drawings, which are included herein as a part of detailed descriptions to help understanding the present disclosure, provide embodiments of the present disclosure and describe technical features of the present disclosure with detailed descriptions below.

FIG. 1 illustrates the trend of transition in vehicle architecture.

FIG. 2 illustrates a vehicle network for a software-defined vehicle.

FIG. 3 illustrates an in-vehicle network and an edge network.

FIG. 4 illustrates a vehicle platform for a software-defined vehicle.

FIG. 5 illustrates a lifecycle of an intent-based system for managing a software-defined vehicle.

FIG. 6 illustrates an intent-based management architecture for a software-defined vehicle according to embodiments of the present disclosure.

FIG. 7 is a block diagram illustrating an intent-based management framework for a software-defined vehicle according to embodiments of the present disclosure.

FIGS. 8 and 9 are flowcharts illustrating an intent-based management method in a vehicular cloud and a software-defined vehicle according to one embodiment of the present disclosure, respectively.

FIG. 10 illustrates an intent-based network testbed for managing software-defined vehicles.

### DETAILED DESCRIPTION

In what follows, embodiments of the present disclosure will be described in detail with reference to appended drawings. It should be noted that known functions or configurations that may obscure the gist of the embodiments are omitted from the description and appended drawings. In addition, throughout the document, unless otherwise explicitly stated, if a particular element is said to “include” some particular element, it means that the former may further include other particular elements rather than exclude them.

The terms such as first and second are introduced to describe various elements, but the elements should not be limited by the terms. The terms are used only for the purpose of distinguishing one element from the other elements. For example, a first element may be called a second element without leaving the technical scope of the present disclosure, and similarly, the second element may be called the first element.

Terms used in this document are intended only for describing a specific embodiment and are not intended to limit the technical scope of the present disclosure. A singular expression should be understood to indicate a plural expression unless otherwise explicitly stated. The term “include” or “have” is used to indicate existence of an embodied feature, number, step, operation, element, component, part, or a combination thereof; and should not be understood to preclude the existence or possibility of adding one or more other features, numbers, steps, operations, elements, components, parts, or a combination thereof.

Unless defined otherwise, all the terms used in the present disclosure, including technical or scientific terms, provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

A software-defined vehicle is composed of a software platform such as a cloud-native system like Kubernetes and includes an internal network. To configure the network in a software-defined vehicle easily and efficiently and to address the problems above, intent-based management may serve as an appropriate solution.

In the present disclosure, the term “intent” refers to a set of operational goals (to be fulfilled by the network) and outcomes (to be delivered by the network), which may be defined declaratively without specifying how they are to be achieved or implemented. In other words, intent represents a declarative command that requests a configuration for a network or security function.

In what follows, an intent-based management framework for the network and applications of a software-defined vehicle is introduced to enable communication with other software-defined vehicles and infrastructure nodes for safe driving and infotainment services in a road network. The proposed framework may also be extended to configure security policies for software-defined vehicles.

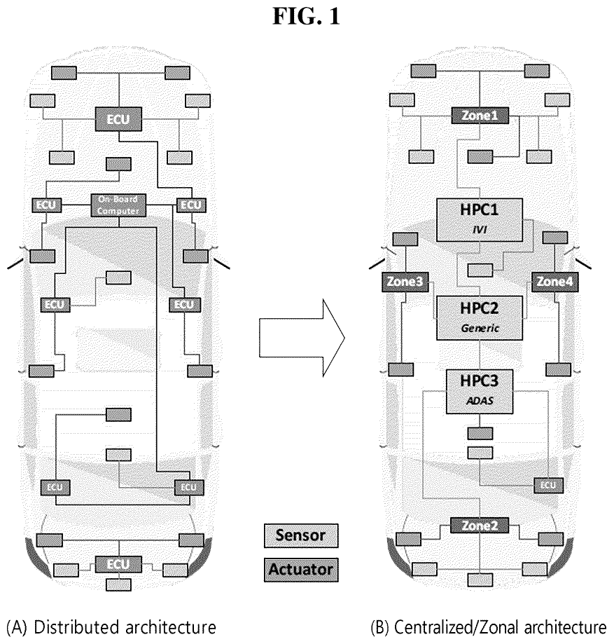

FIG. 1 illustrates the trend of transition in vehicle architecture.

As described above, emergence of software-defined vehicles is bringing about fundamental changes in the automotive industry. Traditional automotive electrical/electronic (E/E) architecture is based on individual electronic control units (ECUs), each responsible for a specific function such as engine control, braking, and in-vehicle infotainment (IVI), as shown in FIG. 1. These ECUs communicate through various bus systems such as Controller Area Network (CAN), Local Interconnect Network (LIN), or FlexRay. As vehicle complexity increases, centralized architecture in which a smaller but more powerful ECU controls multiple functions is being adopted. This architectural transition reduces wiring complexity and weight, thereby enhancing reliability and manufacturability. Alternatively, zonal architecture is being adopted, where the ECUs are grouped into zones based on physical proximity and consists of zonal gateways and vehicle computers connected via a high-speed backbone network. Because zonal gateways are connected to the centralized computing platform through automotive Ethernet, the zonal architecture is considered advantageous for simplifying communication, wiring, and power distribution.

With the emergence of software-defined vehicles, the distinction between hardware and software functionality has become more difficult. A software-defined vehicle may flexibly and dynamically allocate functions and resources by utilizing a powerful onboard high-performance computer (HPC) and a high-speed network backbone, typically employing Ethernet-based Internet Protocol (IP). The software-defined vehicle may also integrate various software functions, including the virtualized network function (VNF), into a single hardware platform through virtualization/containerization technology. This kind of integration may reduce the number of required physical ECUs and network devices (e.g., switches and routers), leading to cost savings, weight reduction, and improved energy efficiency. Furthermore, virtualization may enable the isolation of software applications, thereby enhancing security and stability.

Connected Vehicle Systems Alliance (COVESA) has developed a common Vehicle Signal Specification (VSS) to represent vehicle data for vehicle information services used in both in-vehicle and vehicle-cloud networks. VSS defines a classification system of vehicle signals that may encompass chassis for electric vehicles, fuel system, steering wheel, and properties such as battery information, and various vehicle components including sensors and actuators. Using VSS definitions allows more effective allocation of network resources for vehicles in various scenarios.

When integrating an intent-based network with a software-defined vehicle, it is necessary to consider an intent-based system for software-defined vehicles that addresses both the in-vehicle IP network and the Vehicle-to-Everything (V2X) network. As vehicle applications within software-defined vehicles (e.g., Advanced Driver-Assistance System (ADAS), Automatic Emergency Braking (AEB), Forward Collision Warning (FCW), and Lane Keeping Assist (LKA)) become diversified, the use of virtual network functions for in-vehicle applications is also expanding alongside vehicle-to-vehicle communication through the vehicle-to-vehicle (V2V) network and communication with a cloud (or edge) service through the vehicle-to-infrastructure (V2I) network.

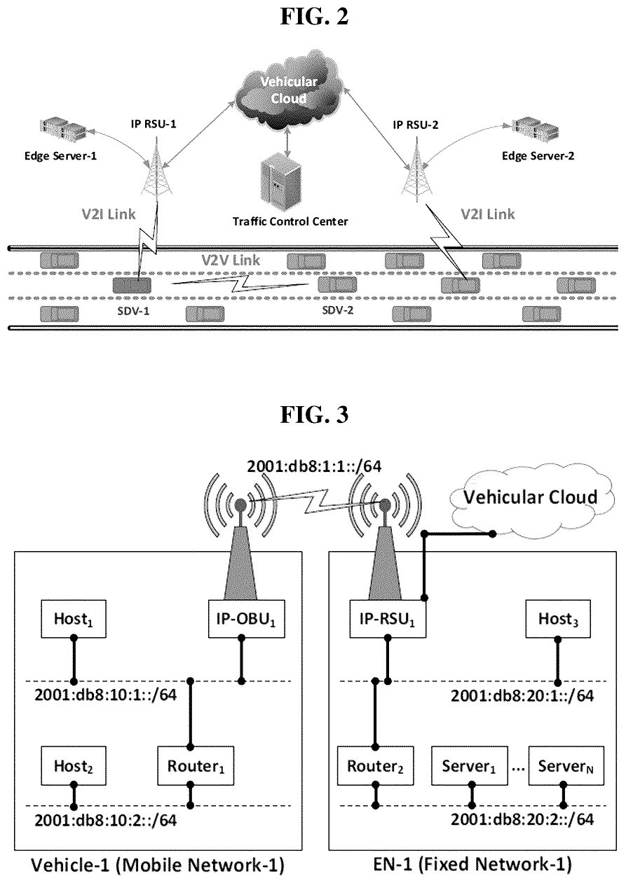

FIG. 2 illustrates a vehicle network for a software-defined vehicle. FIG. 2 shows a vehicle network for a software-defined vehicle capable of communicating with other vehicles or a vehicular cloud.

FIG. 3 illustrates an in-vehicle network and an edge network. Through the in-vehicle network, as shown in FIG. 3, the software-defined vehicle Vehicle-1 and the edge server EN-1 (i.e., Edge Network-1) may communicate with each other. A host within Vehicle-1 may be a vehicle application connected via an in-vehicle Ethernet network and may be virtualized or containerized. EN-1 may provide various services and applications for Vehicle-1 in conjunction with the vehicular cloud.

One of the key driving factors behind intent-based networking is the immense complexity introduced to the network by a multitude of interconnected devices, services, and protocols. Managing such complexity manually is no longer feasible, necessitating the use of intent-based network approaches. Another critical aspect is scalability of recent networks serving millions of users across multiple geographic locations. The scalability feature distinguishes the intent-based network as being more efficient in terms of scale. In terms of operational cost, the intent-based network approach reduces the need for human intervention, thereby achieving faster task execution and reducing the error to enhance efficiency. Meanwhile, networks are dynamic and frequently changed due to factors such as user requirements, traffic patterns, mobility, and security threats. Intent-based networks enable rapid adaptation to such changes. The intent-based network naturally contributes to the advancements in technologies such as artificial intelligence, machine learning, and software-defined networking, thereby making automation more sophisticated and capable. As demand for new services and applications increases, the intent-based network facilitates rapid service delivery and provisioning. Furthermore, the intent-based network assists in enforcing security policies and ensures compliance by consistently applying configurations and policies across the network.

In the field of software-defined vehicle, numerous industry initiatives have been proposed. The AUTomotive Open System Architecture (AUTOSAR) organization has been expanding its architectural design to integrate software-defined vehicles with cloud and edge services. The Scalable Open Architecture For Embedded Edge (SOAFEE) aims to introduce a cloud-native development paradigm to highly diverse and heterogeneous computing platforms for next-generation automotive and safety-critical systems. The Eclipse SDV working group promotes open-source development of automotive software, including software stacks and related tools for core functions of software-defined vehicles. The Connected Vehicle Systems Alliance (COVESA) focuses on connected vehicles and related technologies to fully utilize the potential of connected software-defined vehicles. In particular, COVESA provides vehicle signal specifications to unify vehicle data models.

FIG. 4 illustrates a vehicle platform for a software-defined vehicle, showing a typical software-defined vehicle platform that integrates both conventional architecture and software-oriented architecture. Traditional vehicle E/E hardware components such as electronic control units, sensors, and actuators are grouped for the vehicle's high-performance computer, enabling full utilization of the data generated by the hardware components.

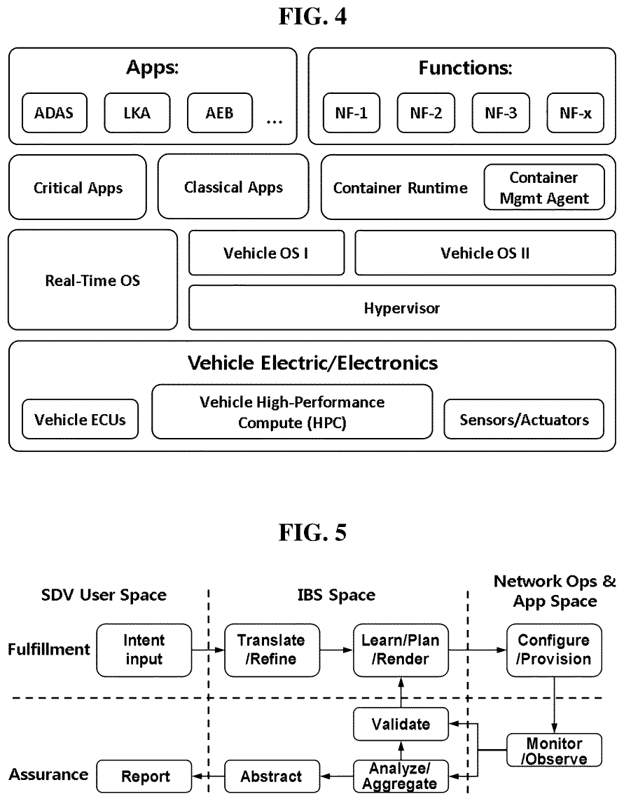

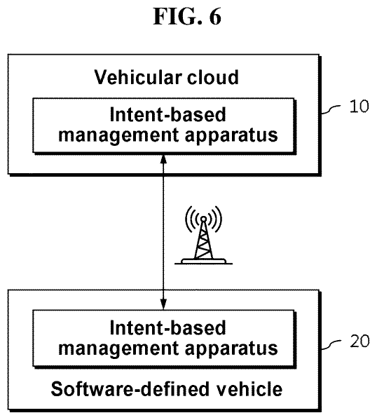

According to the life cycle design of intent-based network, FIG. 5 shows the life cycle of an intent-based network for software-defined vehicle management. The life cycle is divided into three spaces: user space, intent-based system space, and network operation and application space. Each space is further divided into two sections, fulfillment and assurance. The fulfillment section pipelines the steps (i.e., intent input, translation/refinement, learning/planning/rendering, and configuration/provisioning) toward the final service functions such as network functions and applications in software-defined vehicles. The assurance section monitors final results of the intent fulfillment to validate and analyze the resultant network functions (NFs) and applications for SDVs. In what follows, intent-based management architecture for software-defined vehicles that encompasses both network functions and applications within the software-defined vehicle environment.

### Intent-based System for Network Functions of Software-defined Vehicles

Software-defined vehicles are managed and monitored by the vehicular cloud. Software-defined vehicles receive software updates as well as the configuration of their networks and security from the vehicular cloud. Referring to FIG. 2, software-defined vehicles as vehicles may communicate with each other via V2V and with infrastructure nodes (e.g., gNodeB of 5G network) such as IP Road-Side Unit (RSU). An edge server may help software-defined vehicles to perform their safe driving functions by processing environmental data collected by the software-defined vehicles and giving maneuver guidance to the software-defined vehicles.

A software-defined vehicle has its own internal networks (called in-vehicle networks), as shown in FIG. 3. The in-vehicle network consists of multiple subnets connected with each other through routers. IP On-Board Unit (IP-OBU) is a network device in a software-defined vehicle that has a basic processing ability and may be driven by a low-power CPU (e.g., ARM) with a 5G Vehicle-to-Everything (V2X) communication device. The IP Road-Side Unit (IP-RSU) is a network device situated along the road as an infrastructure node. The IP-RSU has at least two distinct IP-enabled interfaces where one is for 5G V2X and the other is for a wired network connected to the vehicular cloud. An Edge Network (EN) is a radio access network which has an IP-RSU for wireless communication with other software-defined vehicles having an IP-OBU and performs wired communication with other network devices (e.g., routers, IP-RSUs, and edge servers). As shown in FIG. 3, the IPV6 prefixes should be configured for both the in-vehicle network (also called mobile network) and the edge network (also called EN). Also, for V2X IP networking, the wireless interfaces of IP-OBU and IP-RSU should be configured with appropriate IPv6 network prefixes and default gateways towards the infrastructure network connected to the vehicular cloud.

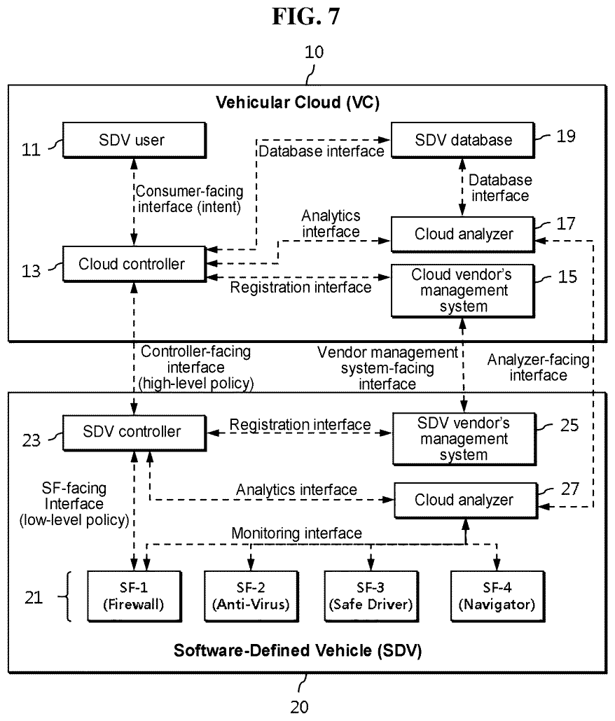

FIG. 6 illustrates an intent-based management architecture for a software-defined vehicle according to embodiments of the present disclosure. The present disclosure proposes a framework for intent-based network management for software-defined vehicles. This framework automates the configuration and monitoring for the networks and security in each software-defined vehicle through a vehicular cloud 10 and the mobile network of the software-defined vehicle 20. To this end, in FIG. 6, the vehicular cloud 10 and the software-defined vehicle 20 are configured respectively to include intent-based management apparatus.

A user (i.e., administrator) responsible for managing software-defined vehicles may configure and monitor network and security functions through intent. The user's intent is delivered to a controller of the vehicular cloud for software-defined vehicles. The controller interprets the intent and converts it into a corresponding high-level policy. Then, the high-level policy is delivered to a software-defined vehicle controller responsible for managing a specific software-defined vehicle. The software-defined vehicle controller is responsible for converting the high-level policy into a corresponding low-level policy. The low-level policy is then dispatched to an appropriate service function (SF) within the software-defined vehicle for a network service (e.g., router, DNS resolver, or firewall) or application service (e.g., a navigator for a safe driver and a human driver for an autonomous vehicle).

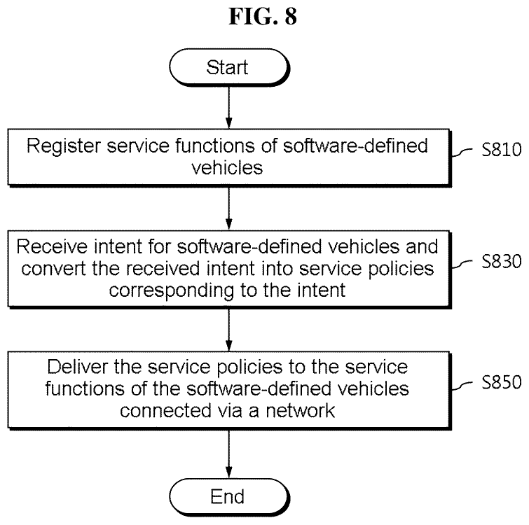

FIG. 7 is a block diagram illustrating an intent-based management framework for a software-defined vehicle according to embodiments of the present disclosure. The framework comprises a vehicular cloud 10 and a software-defined vehicle 20. To automate the network configuration of the software-defined vehicle, intent-based management is required between the vehicular cloud 10 and the software-defined vehicle 20. In what follows, detailed configurations and functions of the vehicular cloud 10 and the software-defined vehicle 20 will be described respectively, based on two distinct entities.

Referring to FIG. 7, the vehicular cloud 10 may comprise a software-defined vehicle user 11, a cloud controller 13, a software-defined vehicle database 19, a cloud analyzer 17, and a cloud vendor's management system 15.

The software-defined vehicle user 11 is the software (e.g., web-browser-based user interface) used by a software-defined vehicle administrator to deliver the network intent to the software-defined vehicle controller. In the 3GPP intent driven management service document, it is assumed that network intent is configured by the intent data model.

The cloud controller 13 is a component that controls and manages other system components of the vehicular cloud. From a security point of view, a security service policy may be transmitted to the service function SF by converting the security service intent of a software-defined vehicle user into the corresponding security service policy and selecting a service function that provides an appropriate security service.

The cloud vendor's management system 15 is a component that provides images of virtualized service functions for vehicular cloud services and registers the service functions and access information with the cloud controller.

The cloud analyzer 17 collects monitoring data from the software-defined vehicle analyzer and evaluates the monitoring data to ensure the functionality and performance of the service function (e.g., the network data analytics function (NWDAF) in the 5G network).

The software-defined vehicle database 19 is a database for managing software-defined vehicles, including network and security configuration information of software-defined vehicles, current location and navigation path of software-defined vehicles.

A management apparatus performing intent-based management for software-defined vehicles in a vehicular cloud according to one embodiment may include the cloud controller 13 and the cloud vendor's management system 15. The cloud controller 13 is configured to receive intent for a software-defined vehicle, convert the intent into a service policy corresponding to the intent, and deliver the service policy to a service function 21 of the software-defined vehicle 20 connected via a network. The cloud vendor's management system 15 is configured to provide images of virtualized service functions for vehicular cloud services and to register service functions and access information with the cloud controller 13. Here, the intent may be configured according to the intent data model of the 3rd Generation Partnership Project (3GPP) intent-based management service specification and delivered to the cloud controller 13 through a consumer-facing interface.

The cloud controller 13 may interpret the received intent, convert the interpreted intent into a corresponding high-level service policy, select an appropriate service function for the software-defined vehicle connected via a network through a controller-facing interface, and deliver the high-level service policy to the selected service function, thereby enabling the software-defined vehicle to convert the high-level service policy into a low-level service policy understood by the service function. At this time, a service function suitable for the intent may be selected by referring to the service functions registered in advance by the cloud vendor's management system 15.

Also, the management apparatus performing intent-based management for a software-defined vehicle in the vehicular cloud 10 according to one embodiment may further include a cloud analyzer 17, which analyzes monitoring data related to service functions collected from software-defined vehicles and provides policy reconfiguration or feedback to the cloud controller 13 through an analytics interface.

The cloud vendor's management system 15 may transfer service function capabilities and access information for registration to the cloud controller 13 or receive service function queries for searching for requested service functions, and exchange service function container images and service function characteristic information with the software-defined vehicle 20 through the vendor's management system (VMS)-facing interface.

Also, the management apparatus performing intent-based management for a software-defined vehicle in the vehicular cloud 10 according to one embodiment may further include a software-defined vehicle database 19, which stores at least one of network and security configuration information of software-defined vehicles, and current locations and navigation paths of software-defined vehicles.

Furthermore, the management apparatus performing intent-based management for a software-defined vehicle in the vehicular cloud 10 according to one embodiment may further include a communication means (not shown) for communicating with the software-defined vehicle via a Road-Side Unit (RSU). Referring to FIGS. 2 and 3, it may be confirmed that the vehicular cloud may communicate with the software-defined vehicle (SDV) via the RSU.

Referring to FIG. 7, the software-defined vehicle 20 may comprise a software-defined vehicle controller 23, a software-defined vehicle analyzer 27, an SDV vendor's management system 25, and service functions (SFs) 21 such as network functions (NFs) (e.g., router, DNS server, firewall, anti-virus), and applications (e.g., safe driver and navigator).

The SDV controller 23 is a component that controls and manages other components of the SDV framework. The SDV controller 23 translates a high-level policy received from the cloud controller 13 into a low-level policy understood by the SF 21. An SF supposed to perform the low-level service policy is selected, and the policy is transmitted to the selected SF.

The SDV vendor's management system 25 is a component that provides an image of a virtualized SF for SDV services to the SDV framework and registers the service function and access information with the SDV controller 23.

The SF 21 is a component that refers to a virtual network function (VNF), cloud native network function (CNF), or physical network function (PNF) for a specific service. For security services, the SF 21 provides security services such as firewalls, web filters, DDOS attack mitigators, and anti-viruses. Also, networks and application services may also operate as SFs.

The SDV analyzer 27 is a component that collects monitoring data from SFs 21 of SDVs and analyzes the collected data to confirm the activity and performance of SFs. The SDV analyzer acts as NWDAF in the 5G network. If there are problems (e.g., security attacks, traffic congestion, QoS degradation) in the SDV internal network, the SDV analyzer 27 delivers either policy reconfiguration or feedback information to the SDV controller 23 for security and network troubleshooting.

The management apparatus performing intent-based management for a software-defined vehicle in the software-defined vehicle (SDV) according to one embodiment may comprise a service function 21, an SDV controller 23, and an SDV vendor's management system 25. The SF 21 includes at least one of the network, security, and application services of the SDV. More specifically, the SF21 may be implemented as one of the virtual network function (VNF), cloud native network function (CNF), and physical network function (PNF) for a specific service. The SDV controller 23 receives a service policy generated in response to the intent for the SDV from the vehicular cloud 10 connected via a network and delivers the received service policy to a service function supposed to perform the service policy. The SDV vendor's management system 25 provides an image of a virtualized service function for the SDV service and registers the service function and access information with the SDV controller 23.

Also, the SDV controller 23 may receive, via the controller-facing interface, a high-level service policy generated in response to the intent for the SDV from the vehicular cloud 10, translate the received high-level service policy into a low-level service policy understood by the SF 21, select an SF supposed to perform the low-level service policy, and deliver the low-level service policy to the selected SF via the service function-facing interface. At this time, a service function suitable for the low-level service policy may be selected by referring to the service functions registered in advance by the SDV vendor's management system 25.

The management apparatus for performing intent-based management in the software-defined vehicle according to one embodiment may further include a software-defined vehicle analyzer 27 that analyzes monitoring data collected from the SFs 21 through a monitoring interface, checks activity and performance of the SFs, delivers policy reconfiguration or feedback information for resolving security and network issues to the SDV controller 23 through the analytics interface, and exchanges at least one of security, network, and system-related analysis of the SFs with the vehicular cloud 10 through the analyzer-facing interface.

The management apparatus for performing intent-based management in the software-defined vehicle according to one embodiment may further include a communication means (not shown) for communicating with the vehicular cloud 10 via a road-side unit (RSU) through a vehicle-to-infrastructure (V2I) network or for forming an in-vehicle network of the SDV. Referring to FIGS. 2 and 3, it may be seen that the SDV may communicate with the vehicular cloud via the RSU or may form a mobile network inside the vehicle.

FIG. 7 defines several interfaces between a pair of system components in the vehicular cloud and the SDV. These interfaces include a consumer-facing interface, a controller-facing interface, a service function-facing interface, a registration interface, a monitoring interface, an analytics interface, an analyzer-facing interface, a vendor's management system-facing interface, and a database interface, which are described below.

The consumer-facing interface is an interface between the SDV user 11 and the cloud controller 13 for conveying intents.

The controller-facing interface is an interface between the cloud controller 13 and the SDV controller 23 for the delivery of a high-level policy through translated intent.

The SF-facing interface is an interface between the SDV controller 23 and the SF 21 for the delivery of a translated lower-level policy.

The registration interface is an interface used to transfer SF capabilities and access information for registration to either the cloud controller 13 or the SDV controller 23 or to deliver SF queries for searching for requested SFs. This interface may be an interface between the cloud controller 13 and the cloud vendor's management system (cloud VMS) 15 or between the SDV controller 23 and the SDV vendor's management system (SDV VMS) 25.

The monitoring interface is an interface between the SF 21 and the SDV analyzer 27, which is used to collect the SF's monitoring data to identify SF-related security, system, and network issues.

The analytics interface is an interface for delivering policy reconfiguration or feedback as a result of analyzing SF monitoring data. This interface is an interface between the SDV analyzer 27 and the SDV controller 23, between the SDV analyzer 27 and the cloud analyzer 17, or between the cloud analyzer 17 and the cloud controller 13.

The analyzer-facing interface is an interface between the SDV analyzer 27 and the cloud analyzer 17 for the exchange of security, network, and system-related analysis of SFs.

The VMS-facing interface is an interface between the cloud VMS 15 and the SDV VMS 25 to exchange SF container images and SF feature information.

The database interface is an interface for exchanging data in an SDV database 19. This interface is an interface between the SDV database 19 and the cloud controller 13 or between the SDV database 19 and the cloud analyzer 17.

In the embodiments of the present disclosure, intent, high-level policies, and low-level policies may be designed using XML or YAML documents. The designed intent, high-level policies, and low-level policies may be delivered to the target components through NETCONF, RESTCONF, or REST API.

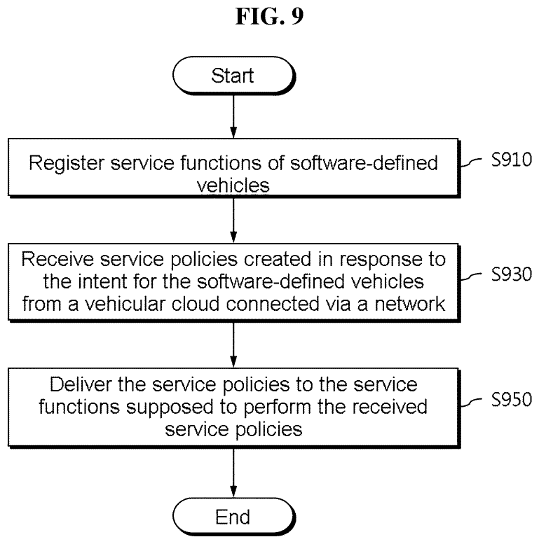

FIGS. 8 and 9 are flowcharts illustrating an intent-based management method in a vehicular cloud and an SDV according to one embodiment of the present disclosure, respectively. Each step is a chronological reconstruction of the components of the intent-based management framework for SDVs described with reference to FIG. 7; here, to avoid redundancy, only the operation or function of each step is briefly described.

Referring to FIG. 8, which illustrates an intent-based management method based on the vehicular cloud, in the S810 step, the management apparatus (of the vehicular cloud) registers a service function of the SDV. Next, in the S830 step, the management apparatus receives intent for the SDV and converts the intent into a corresponding service policy. In other words, the input intent may be interpreted and converted into a high-level service policy corresponding to the interpreted intent. Here, the intent may be structured according to the intent data model defined in the 3rd Generation Partnership Project (3GPP) intent-based management service specification. Then, in the S850 step, the management apparatus delivers the service policy to the service function of the SDV connected via the network. More specifically, the above process may select a service function suitable for the SDV connected via the network and deliver the high-level service policy so that the SDV is guided to convert the high-level service policy into a low-level service policy understood by the selected service function.

Referring to FIG. 9, which illustrates an intent-based management method based on the SDV, in the S910 step, the management apparatus (of the SDV) registers a service function including at least one of the network, security, and application services of the SDV. Here, the service function may be implemented as one of a virtual network function (VNF), a cloud native network function (CNF), or a physical network function (PNF) for a specific service. Next, in the S930 step, the management apparatus receives a service policy generated in response to the intent for the SDV from the vehicular cloud connected via the network. In other words, a high-level service policy generated in response to the intent for the SDV may be received from the vehicular cloud. Then, in the S950 step, the management apparatus delivers the received service policy to the service function supposed to perform the policy. More specifically, the above process may convert the received high-level service policy into a low-level service policy understood by the service function, select the service function supposed to perform the low-level service policy, and deliver the low-level service policy to the selected service function.

Meanwhile, the intent-based management method in the SDV according to one embodiment illustrated in FIG. 9 may further include a process of analyzing monitoring data collected from the service function to identify the activity and performance of the service functions and providing policy reconfiguration or feedback information for resolving security and network issues based on the analysis results.

### Intent-based System for Applications in SDVs

The intent-based system may also manage the applications of the SDVs according to the proposed architecture. The SDV application may include a safe driver (e.g., AI driver) for an autonomous vehicle and a navigator for human drivers.

The safe driver of the SDV may make driving decisions such as steering angle and acceleration/deceleration of the SDV based on environment sensing data from cameras and LiDARs. Also, the safe driver of the SDV may cooperate with other safe drivers to avoid physical collisions by exchanging sensing data and mobility data through wireless communication such as 5G V2X. The safe driver may use the Context-Aware Navigation Protocol (CNP) to collaborate with other safe drivers.

The navigator of the SDV may guide the SDV along the road network using an efficient navigation path. The navigator may actively interact with the vehicular cloud to autonomously determine efficient navigation paths. Since the navigator of the SDV reports navigation paths to the vehicular cloud, the vehicular cloud maintains the latest navigation information of the SDV and performs the role of a coordinator for the SDV, allowing the vehicle to take less congested paths. The navigator may use a Self-Adaptive Interactive Navigation Tool (SAINT) for the SDVs connected to the vehicular cloud.

### Example of Intent-based System in the SDV Environment

To provide a clearer concept of the intent-based system for SDVs, various embodiments have been designed using the proposed architecture of the intent-based system for managing SDVs.

A first scenario may involve a case where an automotive company needs to upgrade and install new applications for a group of vehicles sold to customers (i.e., an over-the-air (OTA) update). It is assumed that the container images of the upgrade and installation applications have already been tested for deployment. Along with the applications, new network functions also have to be deployed to meet the new data traffic requirements in the OTA update, such as bandwidth, jitter, and latency. The SDV users of the automotive company may issue a request such as “Upgrade <Application A> and install it on the vehicle.”

As a second scenario, a fleet management company for SDVs may need to regroup its vehicles for an event to transport people from multiple locations. For this event, an SDV user within the company may provide their intent such as, “Vehicles need to transport people from locations A, B, C, and D from next Monday to Wednesday.” The intent-based system within the company may orchestrate various functions, policies, and network resources for both the in-vehicle network and the V2X network.

To demonstrate a proof of concept (PoC), the embodiments of the present disclosure implement a preliminary intent-based network testbed for managing SDVs. This proof of concept connects SDVs using an open-source cellular network framework.

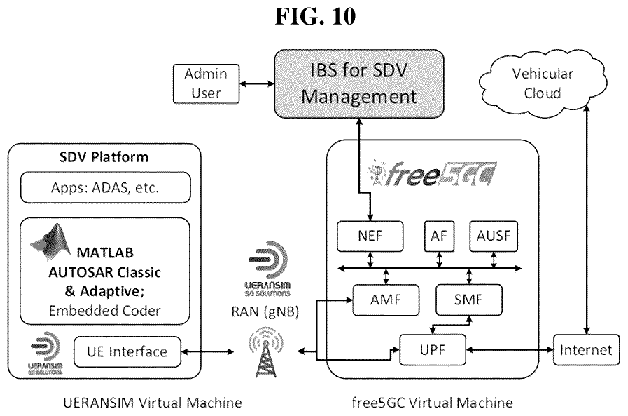

FIG. 10 illustrates an intent-based network testbed for managing SDVs. As illustrated in FIG. 10, for the constructed SDV platform, a vehicle application foundation is created using MATLAB's AUTOSAR modules (i.e., classic and adaptive platforms) and a UERANSIM-based simulated UE interface. The AUTOSAR module may host ADAS equipped with various safe driving applications, such as forward collision warning (FCW), adaptive cruise control, and blind spot monitoring. Also, UERANSIM is used to build a simulated RAN (e.g., gNodeB in a 5G mobile network) that connects to the User Plane Function (UPF) and Access and Mobility Management Function (AMF) of free 5GC's open-source 5G core system (5GCS).

An intent-based system for software-defined vehicle management (IBS for SDV management, ISM) is deployed outside the 5G core system (5GCS), connected to the Network Exposure Function (NEF). The ISM module receives and converts intent and enforces a series of network policy configurations for SDVs and the 5GCS via the NEF. The NEF of the 5GCS provides security APIs that allow all third-party applications to access internal 5GCS functions. In the design according to the embodiments of the present disclosure, the ISM uses the API of the NEF to send translated lower-level policies to the policy control function (PCF) of the 5GCS. The PCF integrates all necessary configurations and installs them into the 5GCS to provide SDVs. Also, the ISM may be located alongside the vehicular cloud. In the 5G testbed, the connectivity between the UE interface of the SDV platform and the data network (i.e., the Internet) was tested via the 5GCS demonstrated online. Accordingly, such functionality may be implemented in future intent-based systems.

The embodiments of the present disclosure may be implemented by various means such as hardware, firmware, software, or a combination thereof. In the case of hardware implementation, one embodiment of the present disclosure may be implemented by using one or more of ASICs (Application Specific Integrated Circuits), DPSs (Digital Signal Processors), DSPDs (Digital Signal Processing Devices), PLDs (Programmable Logic Devices), FPGAs (Field Programmable Gate Arrays), processors, controllers, micro-controllers, and micro-processors. In the case of implementation by firmware or software, one embodiment of the present disclosure may be implemented in the form of modules, procedures, functions, and the like which perform the functions or operations described above. Software codes may be stored in the memory and activated by the processor. The memory may be located inside or outside of the processor and may exchange data with the processor by using various well-known means.

Meanwhile, the embodiments of the present disclosure may be implemented in the form of computer-readable program codes in a computer-readable recording medium. The computer-readable recording medium includes all kinds of recording devices storing data that may be read by a computer system. Examples of computer-readable recording media include a ROM, a RAM, a CD-ROM, a magnetic tape, a floppy disk, and an optical data storage device. Also, the computer-readable recording medium may be distributed over computer systems connected to each other through a network so that computer-readable codes may be stored and executed in a distributed manner. Functional programs, codes, and code segments for implementing the embodiments may be easily inferred by those programmers skilled in the art to which the present disclosure belongs.

More specifically, in one or more non-transitory computer-readable media storing one or more instructions, the one or more instructions executable by one or more processors may perform intent-based management for SDVs, including registering a service function that includes at least one of network, security, and application services of the SDV, receiving a higher-level service policy generated in response to the intent for the SDV from a vehicular cloud connected via a network, converting the received higher-level service policy into a lower-level service policy understood by service functions, selecting a service function to perform the converted lower-level service policy, and delivering the lower-level service policy to the selected service function.

In the description above, a network within the SDV and an intent-based management framework for applications have been proposed. According to the embodiments of the present disclosure, through the proposed framework, virtualized network functions and applications together may be efficiently organized together, and agile reconfiguration of network resources and flexible updates of SDV applications may be performed. Accordingly, it is possible to address management difficulties associated with functions implemented through software applied to a plurality of vehicles, reduce overhead caused by network and security configuration and monitoring within software-defined vehicles, and prevent the increase of costs due to operating offline vehicle service centers.

So far, the present disclosure has been described with reference to the embodiments thereof. It should be understood by those skilled in the art to which the present disclosure belongs that the present disclosure may be implemented in various other modified forms without deviating from the inherent characteristics of the present disclosure. In this respect, the disclosed embodiments should be taken into account in a descriptive point of view rather than restrictive point of view. The technical scope of the present disclosure should be judged by the appended claims rather than the descriptions given above, and all of the discrepancies which may be found within the range equivalent to the technical scope of the present disclosure should be interpreted to belong to the present disclosure.

### DESCRIPTION OF SYMBOLS

10: Vehicular cloud
11: Software-defined vehicle user
13: Cloud controller
15: Cloud vendor's management system
17: Cloud analyzer
19: Software-defined vehicle database
20: Software-defined vehicle
21: Service function
23: Software-defined vehicle controller
25: Software-defined vehicle vendor's management system
27: Software-defined vehicle analyzer

1. A management apparatus for performing intent-based management for a software-defined vehicle (SDV) in a vehicular cloud, the management apparatus comprising:
a cloud controller configured to receive intent for a software-defined vehicle, convert the intent into a corresponding service policy, and deliver the service policy to a service function of the software-defined vehicle connected through a network; and
a cloud vendor's management system configured to provide images of virtualized service functions for vehicular cloud services and register the service functions and access information with the cloud controller.

2. The apparatus of claim 1, wherein the intent is configured according to the intent data model of the 3rd Generation Partnership Project (3GPP) intent-based management service specification and delivered to the cloud controller through a consumer-facing interface.

3. The apparatus of claim 1, wherein the cloud controller interprets the input intent and converts the input intent into a high-level service policy corresponding to the interpreted intent and
selects a service function suitable for a software-defined vehicle connected via a network through a controller-facing Interface and delivers the high-level service policy,
thereby allowing the software-defined vehicle to convert the high-level service policy into a low-level service policy understood by the service function.

4. The apparatus of claim 1, further including:
a cloud analyzer that analyzes monitoring data related to service functions collected from a software-defined vehicle and
provides policy reconfiguration or feedback to the cloud controller through an analytics Interface.

5. The apparatus of claim 1, wherein a cloud vendor's management system transmits service function capability and access information for registration to the cloud controller via a registration interface or receives a service function (SF) query for searching for a requested service function, and
exchanges service function container images and service function characteristic information with a software-defined vehicle via a Vendor Management System-Facing Interface (VMS-Facing Interface).

6. The apparatus of claim 1, further including:
a software-defined vehicle database storing at least one of network and security configuration information of software-defined vehicles, and current locations and navigation paths of software-defined vehicles.

7. The apparatus of claim 1, further including a communication means communicating with the software-defined vehicles through Road-Side Units (RSUs).

8. A management apparatus for performing intent-based management for a software-defined vehicle (SDV), the management apparatus comprising:
a service function including at least one of network, security, and application service of the software-defined vehicle;
a software-defined vehicle controller receiving a service policy generated in response to the intent for the software-defined vehicle from a vehicular cloud connected via a network and delivering the service policy to a service function supposed to perform the service policy; and
a software-defined vehicle vendor's management system providing virtualized service function images for software-defined vehicle services and registering service functions and access information with the software-defined vehicle controller.

9. The apparatus of claim 8, wherein the software-defined vehicle controller receives, through a controller-facing interface, a high-level service policy generated in response to the intent for the software-defined vehicle from a vehicular cloud,
converts the received high-level service policy into a low-level service policy understood by a service function,
selects a service function to perform the low-level service policy, and transmits the low-level service policy to the selected service function through an SF-facing interface.

10. The apparatus of claim 8, further including a software-defined vehicle analyzer configured to:
analyze monitoring data collected from a service function through a monitoring interface to confirm the activity and performance of the service function,
deliver policy reconfiguration or feedback information for resolving security and network issues to the software-defined vehicle controller through an analytics interface, and
exchange at least one of security, network, or system-related analysis of the service functions with the vehicular cloud through an analyzer-facing interface.

11. The apparatus of claim 8, wherein the service function is implemented as one of the virtual network function (VNF), cloud native network function (CNF), and physical network function (PNF) for a specific service.

12. The apparatus of claim 8, further including a communication means for communicating with the vehicular cloud via a road-side unit (RSU) through a vehicle-to-infrastructure (V2I) network or for forming an in-vehicle network of the SDV.

13. An intent-based management method for a software-defined vehicle (SDV) in a vehicular cloud, the method comprising:
registering a service function of the software-defined vehicle by a management apparatus;
receiving intent for the software-defined vehicle and converting the received intent into a corresponding service policy by the management apparatus; and
delivering the service policy to the service function of the software-defined vehicle connected through a network by the management apparatus.

14. The method of claim 13, wherein the intent is configured by an intent data model according to the 3rd Generation Partnership Project (3GPP) intent-based management service specification.

15. The method of claim 13, wherein the converting of the intent into the service policy interprets the input intent and converts the input intent into a high-level service policy corresponding to the interpreted intent, and
the delivering of the service policy selects a service function suitable for a software-defined vehicle connected through a network and delivers the high-level service policy, thereby allowing the software-defined vehicle to convert the high-level service policy into a low-level service policy understood by the service function.

16. An intent-based management method for a software-defined vehicle (SDV), the method comprising:
registering a service function including at least one of network, security, and application services of the software-defined vehicle by the management apparatus;
receiving a service policy generated in response to the intent for the software-defined vehicle from a vehicular cloud connected through a network by the management apparatus; and
delivering the received service policy to the service function supposed to perform the received service policy by the management apparatus.

17. The method of claim 16, wherein the receiving of the service policy receives a high-level service policy generated in response to the intent for the software-defined vehicle from the vehicular cloud, and
the delivering of the service policy converts the received high-level service policy into a low-level service policy understood by a service function, selects a service function supposed to perform the low-level service policy, and delivers the low-level service policy.

18. The method of claim 16, further including:
analyzing monitoring data collected from a service function and confirming the activity and performance of the service function; and
delivering policy reconfiguration or feedback information for resolving security and network issues according to the analysis result.

19. The method of claim 16, wherein the service function is implemented as one of the virtual network function (VNF), cloud native network function (CNF), and physical network function (PNF) for a specific service.

20. In one or more non-transitory computer-readable media storing one or more instructions, a computer-readable medium storing the one or more instructions executable by one or more processors, wherein the one or more instructions are configured to process intent-based management for SDVs, by:
registering a service function including at least one of network, security, and application services of SDVs,
receiving a high-level service policy created in response to the intent for the SDV from a vehicular cloud connected via a network,
converting the received high-level service policy into a low-level service policy understood by service functions, and
selecting a service function supposed to perform the converted low-level service policy and delivering the low-level service policy to the selected service function.
